(19) United States
(12) Patent Application Publication
(10) Pub. No.: US 2026/0109211 A1
(43) Pub. Date: Apr. 23, 2026

(54) MODULAR CANOPY

(71) Applicant: Textron Inc., Providence, RI (US)

(72) Inventors: Ricky Veldee Kemp, Augusta, GA (US); Trevor Douglas Roebuck, Evans, GA (US); Donny Lee Hammond, Augusta, GA (US)

(73) Assignee: Textron Inc., Providence, RI (US)

(21) Appl. No.: 18/919,618

(22) Filed: Oct. 18, 2024

(51) Int. Cl. B60J 7/11; B60J 1/04; B60J 7/19; B60R 16/033; H02S 20/30

(52) U.S. Cl. CPC B60J 7/11; B60J 1/04; B60J 7/194; B60R 16/033; H02S 20/30

(57) ABSTRACT

A canopy assembly for a recreational vehicle includes a first support and a second support. The first support and the second support are configured to couple to the recreational vehicle. The canopy assembly also includes a canopy supported by the first support and the second support. The canopy includes a first panel coupled to the first support and the second support, a second panel coupled to the first support and the second support, a third panel selectively insertable between the first panel and the second panel, and a locking mechanism. The locking mechanism is reconfigurable between a locked position or an unlocked position. When the locking mechanism is in the unlocked position, the third panel is removable from the canopy.

### BACKGROUND

Recreational vehicles are used to transport personnel and equipment between different areas. By way of example, a recreational vehicle may transport golfers and equipment (e.g., golf bags, golf clubs, etc.) around a golf course (e.g., along a cart path, between different holes, etc.).

### SUMMARY

One embodiment relates to a canopy assembly for a recreational vehicle. The canopy assembly includes a first support and a second support. The first support and the second support are configured to couple to the recreational vehicle. The canopy assembly also includes a canopy supported by the first support and the second support. The canopy includes a first panel coupled to the first support and the second support, a second panel coupled to the first support and the second support, a third panel selectively insertable between the first panel and the second panel, and a locking mechanism. The locking mechanism is reconfigurable between a locked position or an unlocked position. When the locking mechanism is in the unlocked position, the third panel is removable from the canopy.

Another embodiment relates to a canopy assembly for a recreational vehicle. The canopy assembly includes a first support and a second support. The first support and the second support configured to couple to the recreational vehicle. The canopy assembly also includes a canopy supported by the first support and the second support. The canopy includes a first panel coupled to the first support and the second support, a strut coupled to the first support and the second support, a second panel coupled to the first support, the second support, and the strut, a third panel selectively insertable between the first panel and the second panel. The third panel includes a first portion and a second portion that are interchangeable, a first locking mechanism coupled to the first portion, and a second locking mechanism coupled to the second portion. The first locking mechanism and the second locking mechanism are configurable between a locked position or an unlocked position where, when in the unlocked position, the first portion or the second portion is independently removable from the canopy. The canopy assembly also includes a windshield assembly coupled to the first support and the second support. The windshield assembly includes a windshield that is repositionable between a closed configuration and an open configuration. The windshield is positioned underneath and substantially parallel to the canopy when in the open configuration. When at least one of the first portion or the second portion is removed from the canopy, a gap is present between the first panel and the second panel. When the windshield is in the open configuration, the windshield at least partially extends across the gap.

Still another embodiment relates to a recreational vehicle. The recreational vehicle includes a chassis, a body coupled to the chassis, a prime mover, and a plurality of tractive elements. At least one of the plurality of tractive elements is driven by the prime mover. The recreational vehicle also includes a first support coupled to at least one of the chassis or the body, a second support coupled to at least one of the chassis or the body, and a canopy supported by the first support and the second support. The canopy includes a first panel coupled to the first support and the second support, a second panel coupled to the first support and the second support, a third panel selectively insertable between the first panel and the second panel, and a locking mechanism. The locking mechanism is reconfigurable between a locked position or an unlocked position. When the locking mechanism is in the unlocked position, the third panel is removable from the canopy. The vehicle also includes a seating assembly supported by the chassis. At least one of the body or the seating assembly defines a storage cavity configured to store the third panel when removed from the canopy.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a perspective view of the vehicle of FIG. 1 with a canopy assembly including a windshield assembly where the canopy assembly is in a locked configuration and the windshield assembly is in a closed configuration, according to an exemplary embodiment.

FIG. 4 is a perspective view of the vehicle of FIG. 3 with the canopy assembly in an unlocked configuration and the windshield assembly in the closed configuration, according to an exemplary embodiment.

FIG. 5 is a perspective view of the vehicle of FIG. 3 with the canopy assembly in an unlocked configuration and the windshield assembly in an open configuration, according to an exemplary embodiment.

FIG. 6 is a side view of the vehicle of FIG. 3, according to an exemplary embodiment.

FIG. 7 is a side perspective view of the vehicle of FIG. 3, according to an exemplary embodiment.

FIG. 8 is a bottom perspective view of the canopy assembly of FIG. 3 in the locked configuration, according to an exemplary embodiment.

FIG. 9 is a detailed bottom perspective view of a portion of the canopy assembly of FIG. 8 in the locked configuration, according to an exemplary embodiment.

FIG. 10 is a detailed bottom perspective view of another portion of the canopy assembly of FIG. 8 in the locked configuration, according to an exemplary embodiment.

FIG. 11 is a detailed bottom perspective view of another portion of the canopy assembly of FIG. 8 in the locked configuration, according to an exemplary embodiment.

FIG. 12 is a perspective view of a first panel of a canopy of the canopy assembly of FIG. 3, according to an exemplary embodiment.

FIG. 13 is a bottom view of the first panel of FIG. 12, according to an exemplary embodiment.

FIG. 14 is a side view of the panel of FIG. 12, according to an exemplary embodiment.

FIG. 15 is a top view of a second panel of a canopy of the canopy assembly of FIG. 3, according to an exemplary embodiment.

FIG. 16 is a bottom view of the canopy assembly of FIG. 3, according to an exemplary embodiment.

FIG. 17 is a top view of a third panel and a fourth panel of a canopy of the canopy assembly of FIG. 3, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

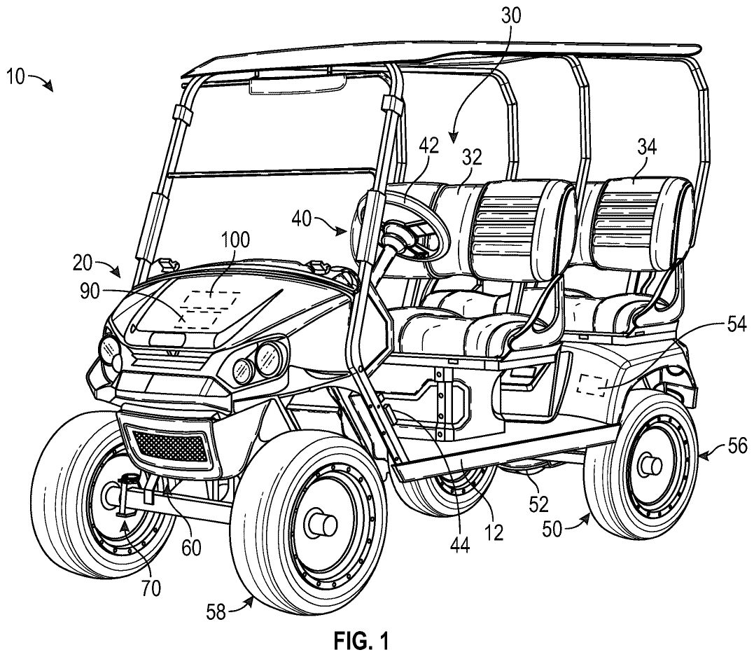

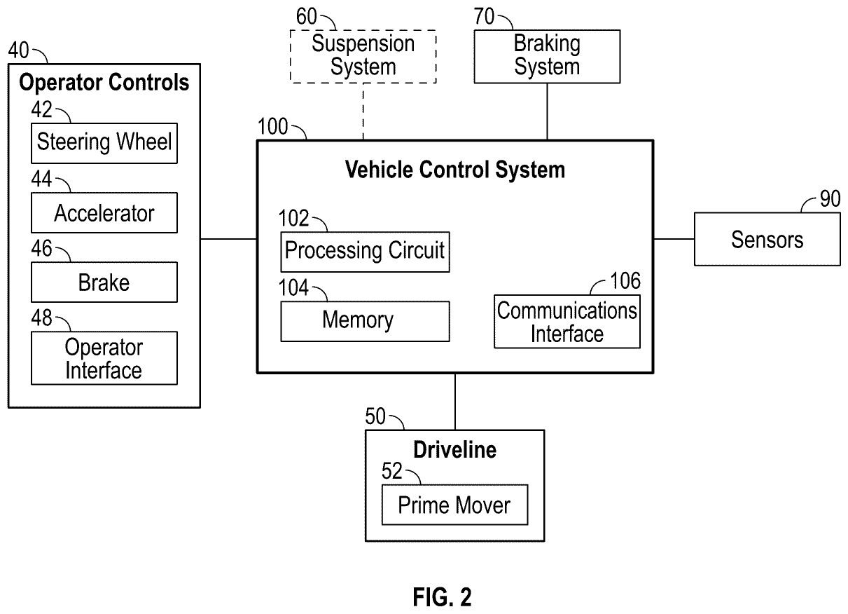

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Modular Canopy Assembly

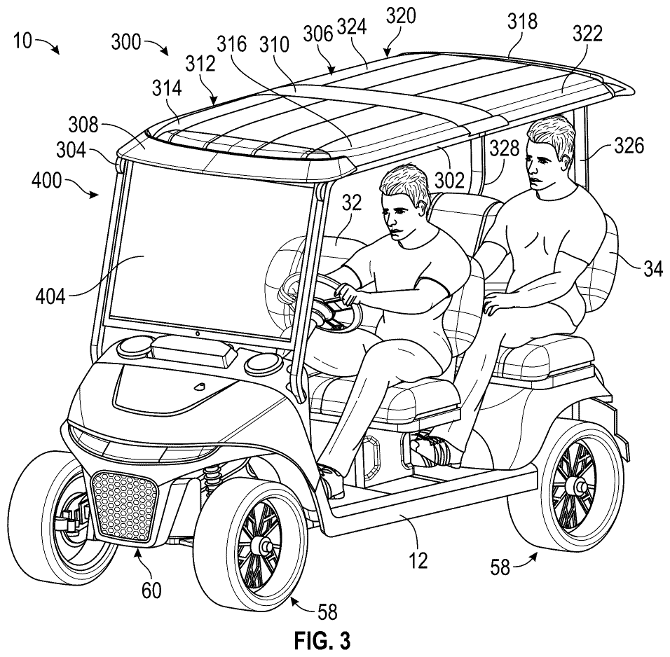

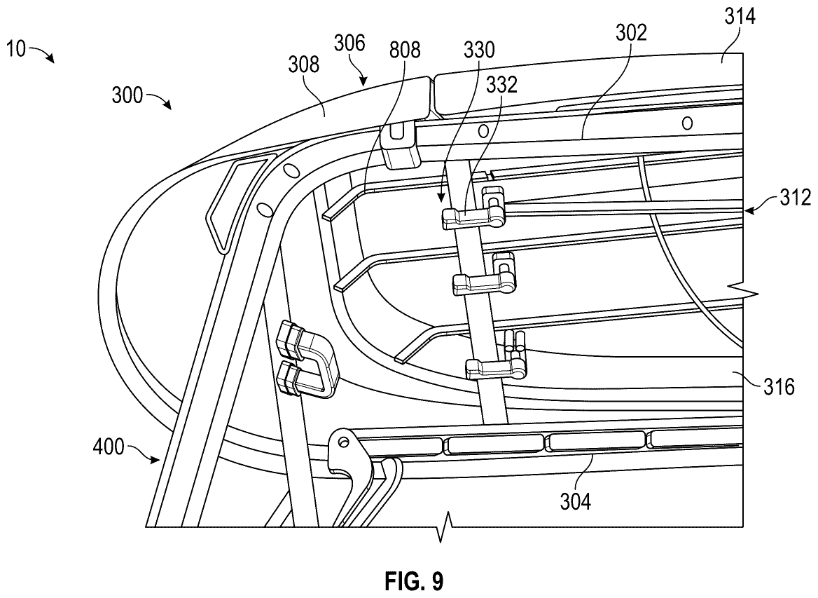

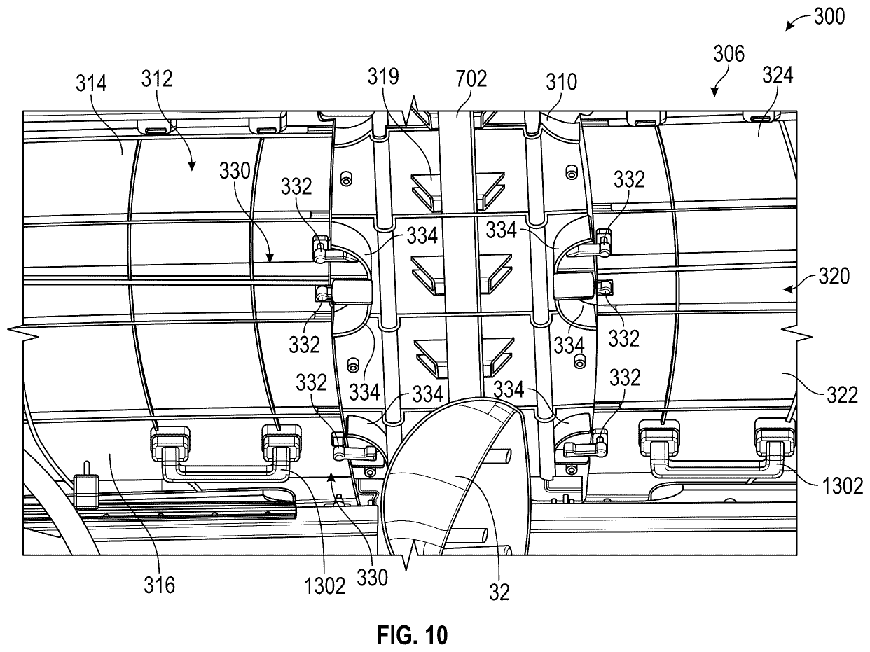

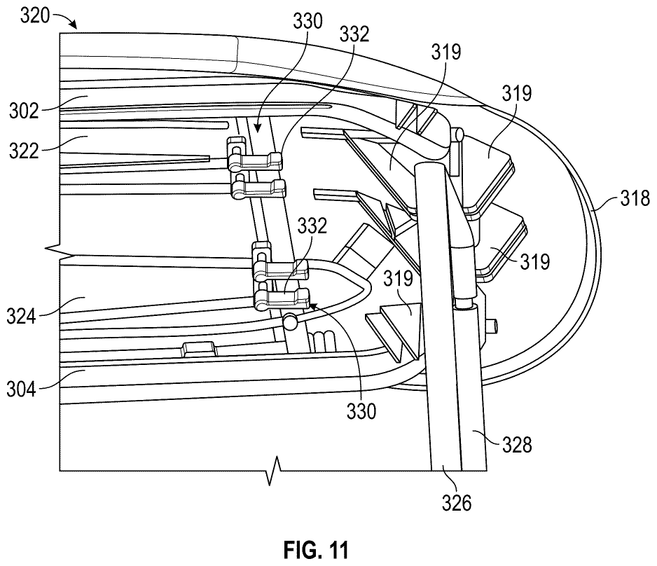

As shown in FIG. 3-11, the vehicle 10 includes a roof assembly, shown as canopy assembly 300. According to an exemplary embodiment, the canopy assembly 300 is supported by the frame 12 of the vehicle 10 (e.g., coupled to the frame 12, etc.). The canopy assembly 300 is positioned above the occupant seating area 30 and is configured to provide shade and protection from inclement weather (e.g., rain, sleet, etc.).

As shown in FIG. 3-11, the canopy assembly 300 includes a first canopy support, shown as first support 302, a second canopy support, shown as second support 304, and a roof, shown as canopy 306. The first support 302 and the second support 304 are configured to couple the canopy 306 to the frame 12 and/or the body 20 of the vehicle 10. In some embodiments, the first support 302 and the second support 304 include or are manufactured from a metallic material (e.g., aluminum). In other embodiments, the first support 302 and the second support 304 are manufactured from another material such as carbon fiber or plastic.

As shown in FIG. 3-5, 7, and 8, the second support 304 is positioned a distance away from the first support 302 on a side of the vehicle 10 opposite the first support 302. The second support 304 is substantially similar to the first support 302. The first support 302 and the second support 304 each include first portions that extend upward from the frame 12 and second portions that extend parallel to the frame 12.

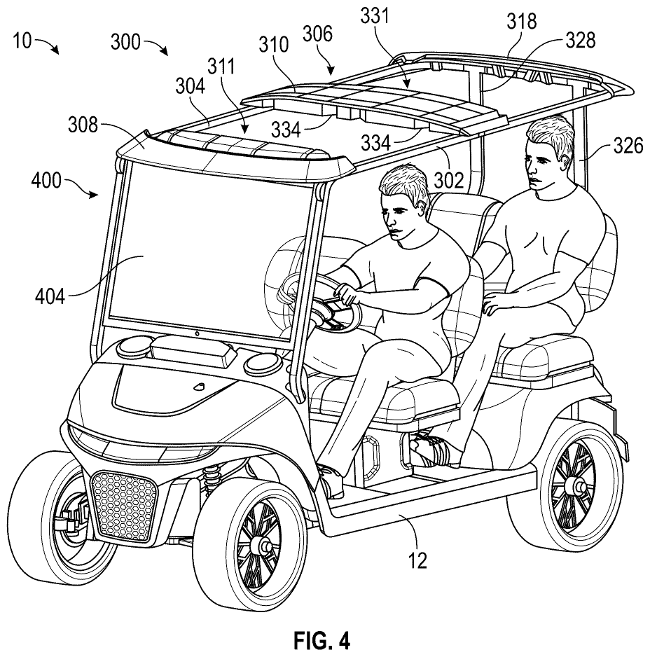

As shown in FIG. 3-6 and 9, the canopy assembly 300 includes a window system, shown as windshield assembly 400. As shown in FIGS. 3 and 4, the windshield assembly 400 is positioned at or proximate to a front end of the vehicle 10. According to an exemplary embodiment, the windshield assembly 400 is configured to shield and/or prevent wind and debris from flowing into the occupant seating area 30 of the vehicle 10.

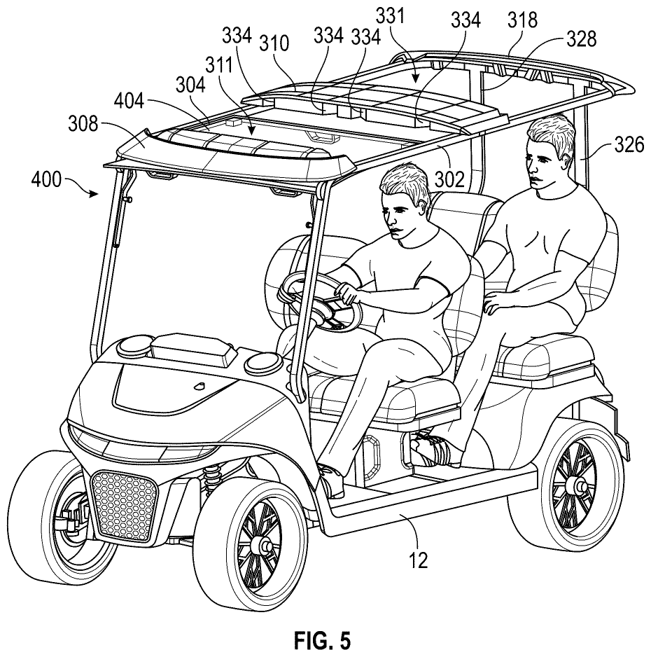

As shown in FIG. 3-6, the windshield assembly 400 is coupled to the first support 302 and the second support 304. The windshield assembly 400 includes a front window, shown as windshield 404. The windshield 404 can be manufactured from a plastic material or a glass material. The windshield assembly 400 is reconfigurable between (a) the closed configuration, as shown in FIGS. 3 and 4, where the windshield 404 is in a closed position and positioned in front of the occupant seating area 30 and positioned at an angle relative to the canopy assembly 300, and (b) an open configuration, as shown in FIG. 5, where the windshield 404 is in an open position and positioned above the occupant seating area 30 and substantially parallel to the canopy assembly 300. Further details regarding the windshield assembly 400 may be found in U.S. patent application Ser. No. 18/911,840, filed Oct. 10, 2024, which is incorporated herein by reference in its entirety.

According to an exemplary embodiment, the canopy 306 includes sections, portions, or panels that are coupled to the first support 302 and the second support 304. As shown in FIG. 3-5 and 7-9, the canopy 306 includes a first section, portion, or panel, shown as front panel 308, that is coupled to (e.g., fixed to, fastened to, attached to, etc.) the first support 302 and the second support 304. The front panel 308 is coupled to a front end of the canopy assembly 300 positioned on a front side of the vehicle 10 (e.g., a side adjacent to the hood or windshield assembly 400, etc.).

As shown in FIG. 3-5, 7, 8, and 10, the canopy 306 includes a second section, portion, or panel, shown as middle panel 310, that is coupled to (e.g., fixed to, fastened to, attached to, etc.) the first support 302 and the second support 304. As shown in FIGS. 4 and 5, the middle panel 310 is positioned near a center of the vehicle 10 above the occupant seating area 30 and spaced a distance away from the front panel 308 such that a first opening, shown as front gap 311, is defined between the front panel 308 and the middle panel 310.

As shown in FIGS. 3 and 7-10, the canopy 306 includes a third section, portion, or panel, shown as front removable panel 312. The front removable panel 312 is selectively insertable or positionable between the front panel 308 and the middle panel 310. For example, the front removable panel 312 is supported by each of the first support 302 and the second support 304 and selectively coupled to or secured to each of the front panel 308 and the middle panel 310. According to an exemplary embodiment, the front removable panel 312 is secured to or releasably coupled to each of the front panel 308 and the middle panel 310, and rests on top of or is supported by the first support 302 and the second support 304. In some embodiments, the front removable panel 312 is additionally or alternatively coupled to, via fasteners or other securing mechanisms, to each of the first support 302 and the second support 304.

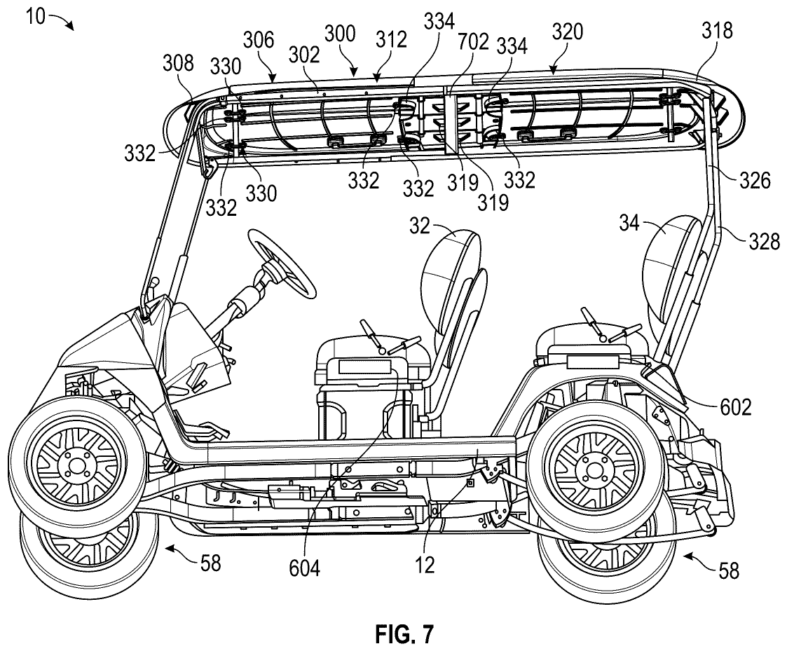

As shown in FIGS. 7, 8, and 10, the canopy assembly 300 includes a lateral support, such as strut 702, extending from, and is coupled to, the first support 302 on a first side of the vehicle 10 to the second support 304 on the second side of the vehicle 10 and is aligned with the middle panel 310. For example, the strut 702 extends parallel with the middle panel 310. The strut 702 may be manufactured from a metallic material (e.g., aluminum) and configured to support the middle panel 310. In other embodiments, the strut 702 may be manufactured from a plastic material. In some embodiments, the middle panel 310 snaps onto, clips onto, or otherwise interfaces with the strut 702. In some embodiments, the strut 702 includes electrical interfaces or electrical wiring is routed therethrough, as described in more detail below.

As shown in FIGS. 3 and 7-10, the front removable panel 312 includes a first sub-panel portion, shown as first front removable panel portion 314, and a second sub-panel portion, shown as second front removable panel portion 316. The first front removable panel portion 314 is positioned between the front panel 308 and the middle panel 310 and is adjacent to the first support 302. The second front removable panel portion 316 is positioned between the front panel 308 and the middle panel 310 and is adjacent to the second support 304 and the first front removable panel portion 314. In some embodiments, edges of the first front removable panel portion 314 that contact, or interface with, edges of the second front removable panel portion 316, the front panel 308, and the middle panel 310 include a seal or sealing member. Each of the first front removable panel portion 314 and the second front removable panel portion 316 are selectively insertable between the front panel 308 and the middle panel 310 such that a user can choose to insert or remove one of the first front removable panel portion 314 or the second front removable panel portion 316 independently. For example, the user can choose to insert only the first front removable panel portion 314 such that the driver is covered or shaded by the first front removable panel portion 314 and a passenger seated adjacent to the driver is not shaded. In other embodiments, the front removable panel 312 is a continuous panel that extends between the front panel 308, the middle panel 310, the first support 302, and the second support 304.

As shown in FIG. 3-5, 7, 8, and 11, the canopy 306 includes a fourth section, portion, or panel, shown as rear panel 318, that is coupled to (e.g., fixed to, fastened to, attached to, etc.) the first support 302 and the second support 304. The rear panel 318 is coupled to a rear end of the canopy assembly 300 positioned on a rear side of the vehicle 10 opposite the front panel 308. According to this embodiment, the front panel 308, the middle panel 310, and the rear panel 318 are secured to, or fixedly coupled, to the first support 302 and the second support 304. As shown in FIGS. 7, 8, 10, 11, and 16, the front panel 308, the middle panel 310, and the rear panel 318 are coupled to the first support 302, the second support 304, and the strut 702 with a plurality of couplers, shown as fastener mechanisms 319. The fastener mechanisms 319 may include clips, flanges, bracketry, etc. that facilitate coupling the front panel 308, the middle panel 310, and the rear panel 318 to the first support 302, the second support 304, and the strut 702 with using fasteners (e.g., screws, bolts, rivets, etc.).

As shown in FIGS. 4 and 5, the rear panel 318 is positioned near the rear of the vehicle 10 above the occupant seating area 30 and spaced a distance away from the middle panel 310 such that a second opening, shown as rear gap 331, is defined between the middle panel 310 and the rear panel 318. As shown in FIGS. 3, 7, 8, 10, and 11, the canopy 306 includes a fifth section, portion, or panel, shown as rear removable panel 320. The rear removable panel 312 is selectively insertable or positionable between the middle panel 310 and the rear panel 318. For example, the rear removable panel 320 is supported by each of the first support 302 and the second support 304 and selectively coupled to or secured to each of the middle panel 310 and the rear panel 318. According to an exemplary embodiment, the rear removable panel 320 is secured to or releasably coupled to each of the middle panel 310 and the rear panel 318, and rests on top of or is supported by the first support 302 and the second support 304. In some embodiments, the rear removable panel 320 is additionally or alternatively coupled to, via fasteners or other securing mechanisms, to each of the first support 302 and the second support 304.

In some embodiments, the rear removable panel 320 is substantially similar to the front removable panel 312. In such embodiments, the front removable panel 312 and the rear removable panel 320 are interchangeable or switchable. For example, the rear removable panel 320 can be positioned between the front panel 308 and the middle panel 310 and the front removable panel 312 can be inserted or positioned between the middle panel 310 and the rear panel 318.

As shown in FIGS. 3, 7, 8, 10, and 11, the rear removable panel 320 includes a first sub-panel portion, shown as first rear removable panel portion 322, and a second sub-panel portion, shown as second rear removable panel portion 324. The first rear removable panel portion 322 is positioned between the middle panel 310 and the rear panel 318 and is adjacent to the first support 302. The second rear removable panel portion 324 is positioned between the middle panel 310 and the rear panel 318 and is adjacent to the second support 304 and the first rear removable panel portion 322. In some embodiments, edges of the first rear removable panel portion 322 that contact, or interface with, edges of the second rear removable panel portion 324, the middle panel 310, and the rear panel 318 include a seal or sealing member. Each of the first rear removable panel portion 322 and the second rear removable panel portion 324 are selectively insertable between middle panel 310 and the rear panel 318 such that a user can choose to insert or remove one of the first rear removable panel portion 322 or the second rear removable panel portion 324 independently. For example, the user can choose to insert only the first rear removable panel portion 322 and not the second rear removable panel portion 324. In other embodiments, the rear removable panel 320 is a continuous panel that extends between the middle panel 310, the rear panel 318, the first support 302, and the second support 304.

In some embodiments, two or more of the first front removable panel portion 314, the second front removable panel portion 316, the first rear removable panel portion 322, and the second rear removable panel portion 324 are interchangeable. In some embodiments, the canopy 306 does not include the middle panel 312. In such embodiments, the front removable panel 312 and the rear removable panel 320 may engage with one another or the front removable panel 312 and the rear removable panel 320 may form a single, continuous panel.

As shown in FIG. 3-8 and 11, the canopy assembly 300 includes a third canopy support, shown as first rear support 326, and a fourth canopy support, shown second rear support 328, extending downward from and coupled to rear ends of the first support 302 and the second support 304, respectively. The first rear support 326 and the second rear support 328 are configured to further support the canopy 306 and further couple the canopy assembly 300 to the vehicle 10.

As shown in FIG. 7-16, the canopy assembly 300 includes a canopy lock or release system including a plurality of locking mechanisms, shown as locking mechanisms 330, that facilitates selectively securing and releasing the front removable panel 312 and the rear removeable panel 320 from the canopy 306. For example, at least one locking mechanism 330 is coupled to the front removable panel 312 and at least one locking mechanism 330 is coupled to the rear removable panel 320. In some embodiments, the locking mechanisms 330 are additionally or alternatively positioned on the front panel 308, the middle panel 310, and/or the rear panel 318.

As shown in FIG. 7-10, the front removable panel 312 includes a plurality of the locking mechanisms 330. More specifically, each of the first front removable panel portion 314 and the second front removable panel portion 316 of the front removable panel 312 includes one or more of the locking mechanisms 330 (e.g., one, two, etc.) positioned near a first edge or side thereof that is adjacent to the front panel 308 and one or more of the locking mechanisms 330 (e.g., one, two, etc.) positioned near a second edge or side opposite the first edge or side, and adjacent to the middle panel 310.

As shown in FIGS. 7, 8, 10, and 11, the rear removable panel 320 includes a plurality of the locking mechanisms 330. More specifically, each of the first rear removable panel portion 322 and the second rear removable panel portion 324 of the rear removable panel 320 includes one or more of the locking mechanisms 330 (e.g., one, two, etc.) positioned near a first edge or side thereof that is adjacent to the middle panel 310 and one or more of the locking mechanisms 330 (e.g., one, two, etc.) positioned near a second edge or side opposite the first edge or side, and adjacent to the rear panel 318.

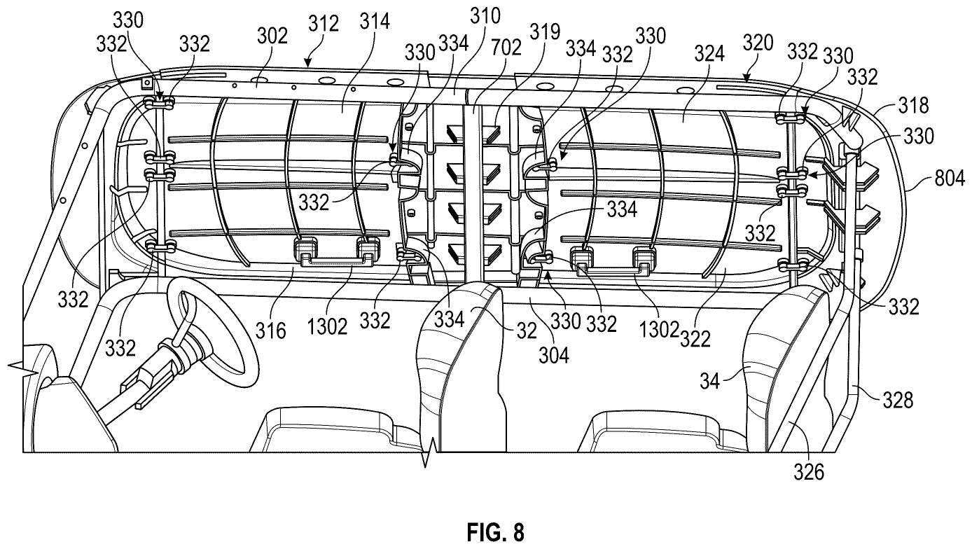

As shown in FIG. 8-17, the locking mechanisms 330 include retainers, shown as latches 332, that are coupled to and extend away from the front removable panel 312 and the rear removable panel 320 to secure, or selectively couple, the front removable panel 312 and the rear removable panel 320 to one of the front panel 308 and the middle panel 310 or the middle panel 310 and the rear panel 318, respectively. According to this embodiment, the latches 332 are pivotably coupled to the front removable panel 312 and the rear removable panel 320. As such, the latches 332 are pivotably movable between a locked positioned and an unlocked position. In other embodiments, the locking mechanisms 330 include a slidable latch that translates in a direction parallel to each of the first support 302 and the second support 304. In some embodiments, the locking mechanisms 330 are a spring biased latches that are releasable by a release button, lever, or other interface. In some embodiments, the locking mechanisms 330 are additionally or alternatively positioned and configured to engage with the first support 302 and the second support 304.

As shown in FIGS. 3 and 7-11, the latches 332 are positioned in the locked position such that the front removable panel 312 and the rear removable panel 320 are secured to either the front panel 308 and the middle panel 310, or the middle panel 310 and the rear panel 318, respectively. According to this exemplary embodiment, when the locking mechanisms 330, are in the locked position, the latches 332 extend in a direction parallel to the first support 302 and the second support 304 and engage with, or contact, one of the front panel 308, the middle panel 310, or the rear panel 318. When the locking mechanisms 330 are in the unlocked position, the latches 332 are rotated or pivoted such that the latches 332 extend in a direction substantially perpendicular to the first support 302 and the second support 304 such that the latches 806 do not extend past an edge of the front removable panel 312 or the rear removable panel 320. For example, it is advantageous that the locking mechanisms 330, including the latches 332 according to this embodiment, do not extend or protrude beyond the edges of the panels (e.g., the front removable panel 312 or the rear removable panel 320, etc.) in the unlocked position such that the locking mechanisms 330 are protected and/or shielded by the panels when in the unlocked position and are more robust for storage.

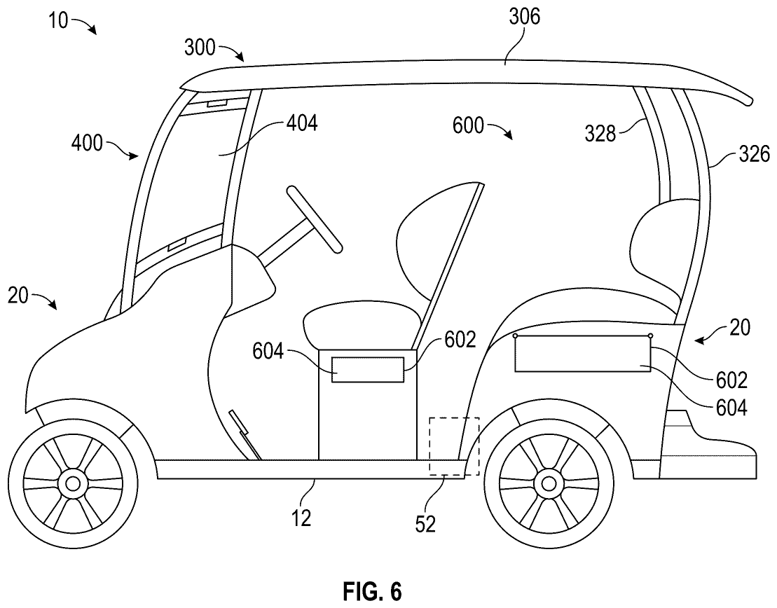

As shown in FIGS. 6 and 7, the vehicle 10 includes a seating assembly 600. The seating assembly 600 is positioned in the occupant seating area 30 and includes the plurality of rows of seating including the front row seating 32 and the rear row seating 34. The primer mover 52 is at least partially positioned forward of the rear tractive assembly 56 (e.g., offset forward of a rear axle of the rear tractive assembly 56) such that the prime mover 52 is below and at least partially in front of the rear row seating 34, providing space underneath the rear row of seating 34. The body 20 and/or the seating assembly 600, such as the portion of the seating assembly 600 below the front row seating 32 or the rear row seating 34, includes a storage area or compartment, shown as storage cavity 602, configured to receive at least one of the front removable panel 312 and the rear removable panel 320 for storing. The vehicle 10 may include multiple storage cavities 602 (e.g., one for each panel etc.). As shown in FIGS. 6 and 7, the vehicle 10 include flaps or doors, or covers 604, that cover an opening to the storage cavities 602. For example, a user can open the covers 604 and slide the front removable panel 312 and/or the rear removable panel 320 into the storage cavities 602.

As shown in FIGS. 4 and 5, the front removable panel 312 and the rear removable panel 320 are removed. As such, sunlight can penetrate through to the front gap 311 and the rear gap 331 onto the passengers in the occupant seating area 30 (e.g., front and rear passengers, etc.). As shown in FIG. 4-7, 10, and 16, the middle panel 310 includes interfaces, shown as recesses 334, that are configured to receive the latches 332 of the locking mechanisms 330. According to this embodiment, the recesses 334 are shaped to correspond to the pivoting motion of the latches 332 (e.g., quarter of a circle shaped, etc.). In other embodiments, the middle panel 310 does not include the recesses 334 and instead is configured such that a bottom surface of the middle panel 310 is substantially flat and configured to receive the latches 332. According to this embodiment, the front panel 308 and the middle panel 310 are configured such that the bottom surface of each of the front panel 308 and the middle panel 310 are configured to receive and engage with the latches 332 when the locking mechanisms 330 are positioned in the locked position.

As shown in FIG. 5, when the front removable panel 312 and the rear removable panel 320 are removed from the canopy assembly 300, the windshield assembly 400 is positionable in an open position such that the windshield 404 extends partially across the front gap 311. As such, the windshield 404 is configured to cover at least portion of the front gap 311 and functions like a transparent canopy.

### Modular Canopy Panels

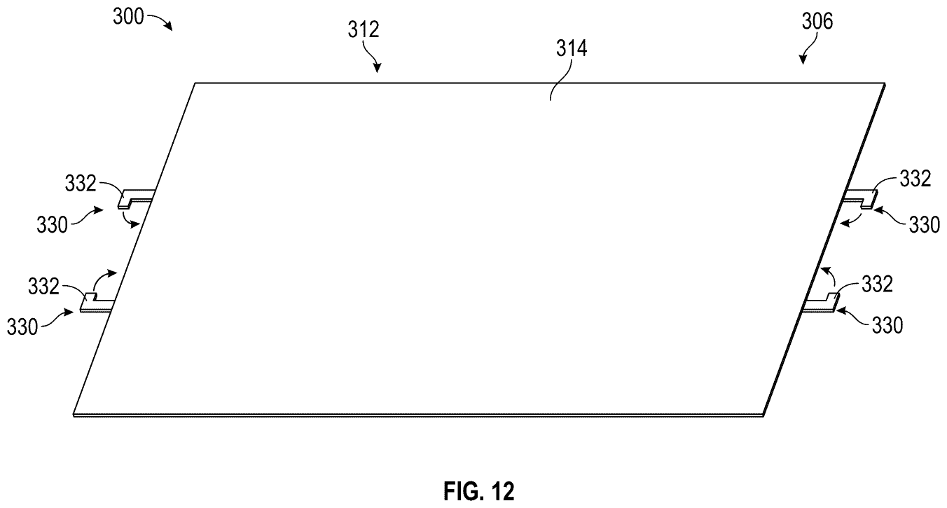

As shown in FIG. 12-17, various different types of panels are shown that be used with the canopy 306 to provide a modular functionality to the canopy assembly 300. It should be understood that the embodiments of FIG. 12-17 may apply to any of the first front removable panel portion 314, the second front removable panel portion 316, the first rear removable panel portion 322, and the second rear removable panel portion 324. It should also be understood that the various different types of panels shown in FIG. 12-17 is not exhaustive, and various other types of panels may be used with the canopy assembly 300.

As shown in FIG. 12-14, the front removable panel 312, such as the first front removable panel portion 314, has substantially flat top surface configured to shield or cover a passenger from weather, such as rain, or the sun. In other embodiments, the first front removable panel portion 314 has a domed profile. As shown in FIG. 12-14, the locking mechanisms 330 are disposed along a bottom surface and include the latches 332. According to this embodiment, the latches 332 are in the locked position in which an end of the latches 332 protrudes outward from opposite ends of the first front removable panel portion 314. The latches 332 can rotate inward towards a center of the panel (e.g., clockwise or counterclockwise, etc.).

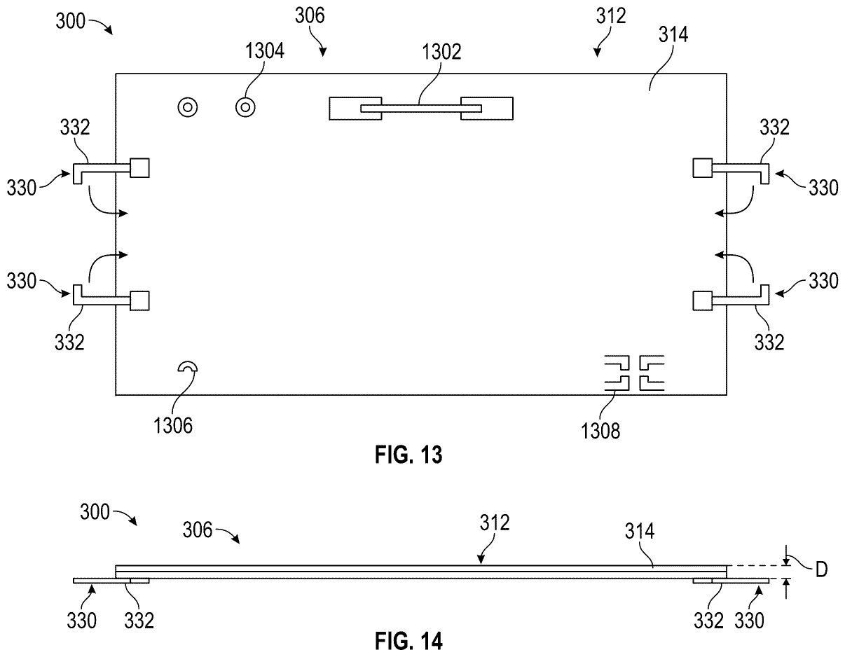

As shown in FIG. 13, the bottom surface of the first front removable panel portion 314 of the front removable panel 312 includes various accessories and/or mounting mechanisms for coupling additional accessories to the first front removable panel portion 314 of the front removable panel 312 of the canopy 306. The first front removable panel portion 314 includes a handle 1302 coupled proximate a peripheral edge of the bottom surface of the first front removable panel portion 314. The first front removable panel portion 314 also includes mounting mechanisms, such as threaded recesses 1304 (e.g., screw holes, etc.), configured to receive a bolt or screw, mounting rings 1306, and clips 1308, such that the user can secure or couple one or more accessories to the bottom surface of the first front removable panel portion. For example, a user may want to secure a speaker, a light, a monitor/display, and/or a range finder to the first front removable panel portion 314 for easy access on a golf course.

As shown in FIG. 14, the front removable panel 312 has a depth D. As such, the canopy 306 extends upwards a distance (e.g., depth D, etc.) above the first support 302 and the second support 304 such that when the windshield 404 is in an open position, as shown in FIG. 4, there is enough space for the accessories to remain coupled or attached to the canopy 306 (e.g., via the mounting mechanisms as previously described).

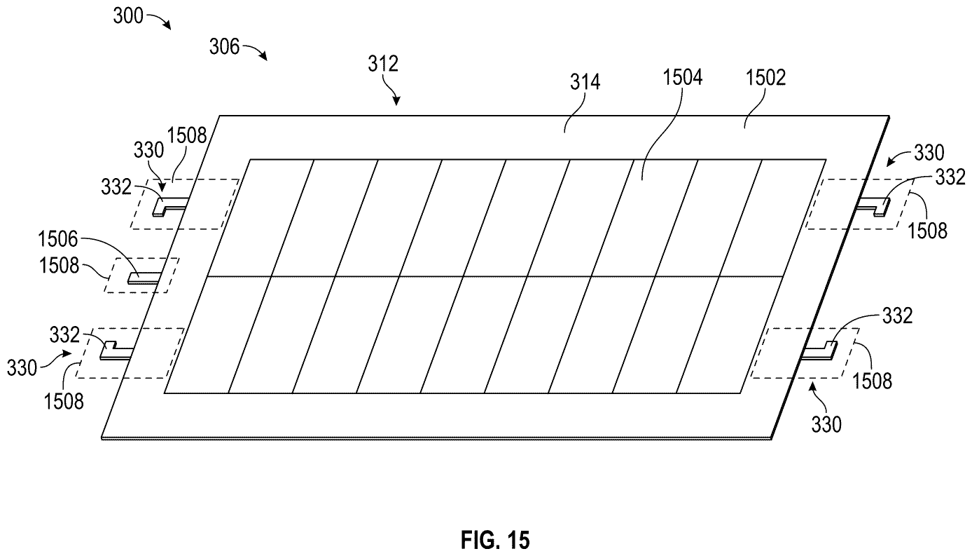

As shown in FIG. 15, the first front removable panel portion 314 additionally includes a photovoltaic array, shown as solar panel 1504, on a top surface 1502 of the front removable panel 312. The solar panel 1504 is configured to generate power from solar energy and provides the power via an electrical connection 1508 through at least one of a connector 1506 or the latches 332 of the locking mechanisms 330 to the energy storage 54 or to an outlet for powered accessories, such as a speaker. For example, the solar panel 1504 may provide power back to the energy storage 54 to power the vehicle 10 and/or provide power to various accessories connected to the vehicle 10.

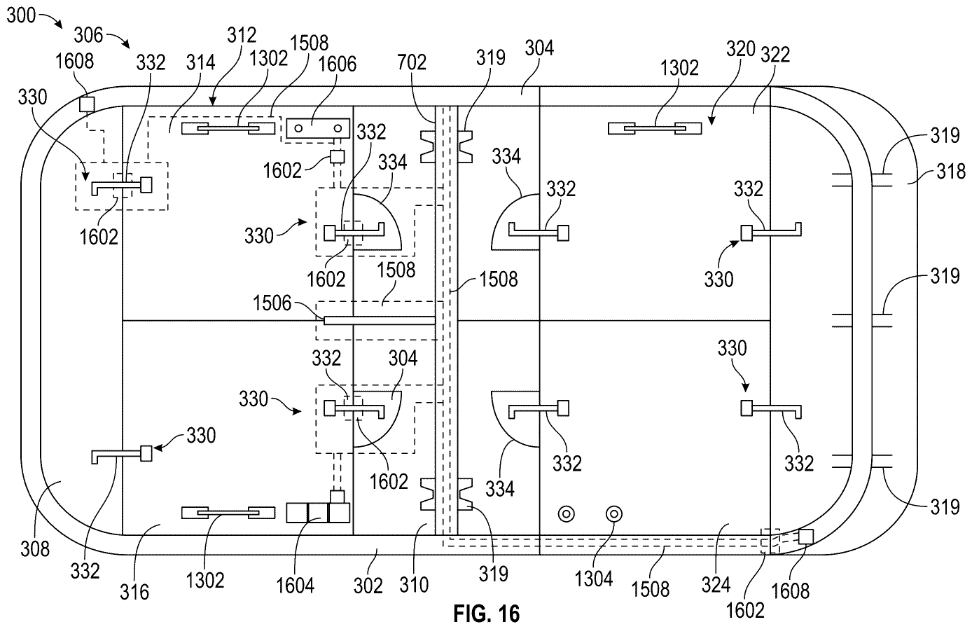

As shown in FIG. 16, is a bottom side of the canopy 306 including the front removable panel 312 and the rear removable panel 320, as shown in any one of FIG. 3-15. According to this embodiment, the front removable panel 312 includes a plurality of handles 1302 and a variety of mounting mechanism, including but not limited to, the threaded recesses 1304, configured to secure accessories, such as a speaker 1606 or a range finder 1604 to the canopy 306.

As shown in FIG. 16, power may be provided via the electrical connections 1508 through the canopy assembly 300, the energy storage 54, and/or the accessories. For example, the canopy 306 includes a plurality of electrical interfaces, shown as electrical interfaces 1602, configured to provide electrical power across various panels. As shown in FIG. 16, the supports 302, 304, 326, 328, and/or strut 702 include the electrical connection 1508 to a battery, such as the energy storage 54, and the energy storage 54 can provide power, though wires within the supports 302, 304, 326, 328, and/or strut 702 to the canopy assembly 300. For example, power may be provided, via wired connection, through the first support 302 or the second support 304 to the strut 702. For example, the wired connection may run from the energy storage 54 up through the strut 702 and to the various panels of the canopy 306. The strut 702 and/or the middle panel 310 includes a plurality of electrical interfaces 1602 configured to receive, via the electrical connections 1508 of one of the electrical connector 1506 or the latches 332 of the locking mechanism 330, electrical power. The electrical interface 1602 is an electrical connection point, such as an outlet, port, or contactor, that the user can selectively connect to accessories, such as a speaker. For example, the electrical interface 1602 may comprise an outlet and be electrically coupled, or provide electrical power, to other wired connections to provide electrical power to additional locations or positions on the front removable panel 312. For example, the front removable panel 312 includes a second electrical connection, or second electrical interface 1602 that receives electrical power via one of the latches 332 to provide power to various locations on the front panel 310. The front panel 308 includes additional wired connections, such as electrical connections 1508, that provide electrical power to accessories such as lights 1608. For example, as shown in FIG. 16, power may be provided from one of the energy storage 54, or a solar panel, such as solar panel 1504, to through the strut 702, and the strut 702 provides the electrical power through one of the electrical connector 1506 or the latches 332 of the locking mechanism 330 to the front removable panel 312 to power a light or a plurality of lights positioned on top of the canopy 306. As shown in FIG. 16, the various wiring, or electrical connections 1508 are positioned within structures, such as the first support 302, the second support 304, the strut 702, or the latches 332, providing power to various locations of the canopy 306, such as the front, back, and sides. The electrical interfaces 1602 allow the user to selectively couple, or connect, desired electrical accessories. In embodiments that include a photovoltaic array, shown as the solar panel 1504 in FIG. 15, the power generated by the solar panel 1504 is provided via the electrical connections 1508 and the electrical interfaces 1602 back to the energy storage 54. For example, electrical power flows through the electrical connections 1508 and the wiring within the supports 326 and 328 into the energy storage 54 to power the vehicle 10 or store for use by various accessories on the vehicle 10.

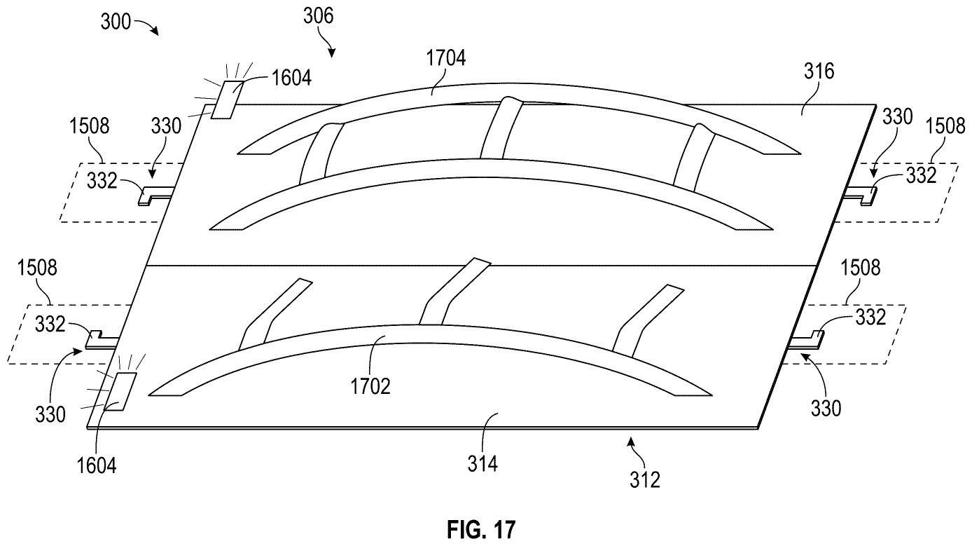

As shown in FIG. 17, the first front removable panel portion 314 and the second front removable panel portion 316 include racks, shown as first rack 1702 and second rack 1704. The first rack 1702 and/or the second rack 1704 may be configured to secure a bike, ladder, fishing rods, a kayak, etc. to the canopy 306.

In some embodiments, the canopy assembly 300 includes a plurality of different types of panels including the various embodiments of FIG. 12-17 such that the user can select panels with desirable features, such as solar panels 1504 and electrical connections 1508 and interfaces 1602, or racks 1702, 174. In some embodiments, the front removable panel 312 or the rear removable panel 320 may include any combination of portions described and shown in FIG. 12-17 such that the user can customize the canopy assembly 300.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) as shown in the various exemplary embodiments is illustrative only. Additionally, any element disclosed in one embodiment may be incorporated or utilized with any other embodiment disclosed herein.

1. A canopy assembly for a recreational vehicle, the canopy assembly comprising:
a first support;
a second support, the first support and the second support configured to couple to the recreational vehicle;
a canopy supported by the first support and the second support, the canopy including:
a first panel coupled to the first support and the second support;
a second panel coupled to the first support and the second support;
a third panel selectively insertable between the first panel and the second panel;
a locking mechanism reconfigurable between a locked position or an unlocked position, wherein, when in the unlocked position, the third panel is removable from the canopy.

2. The canopy assembly of claim 1, wherein the locking mechanism includes a plurality of latches, each of the plurality of latches movably coupled to the third panel and configured to releasably couple the third panel to one of the first panel or the second panel.

3. The canopy assembly of claim 2, wherein when in the locked position, at least one of the plurality of latches extends in a direction parallel to a longitudinal axis of the canopy, and wherein when in the unlocked position, the latch extends in a direction perpendicular to the longitudinal axis.

4. The canopy assembly of claim 2, wherein each of the first panel and the second panel defines one or more recesses configured to receive one or more of the plurality of latches when the locking mechanism is in the locked position.

5. The canopy assembly of claim 1, further comprising a strut coupled to the first support and the second support, the strut aligned with the second panel and configured to at least partially support the second panel.

6. The canopy assembly of claim 5, wherein at least one of the first panel, the second panel, or the strut includes an electrical interface configured to electrically couple to a battery of the recreational vehicle.

7. The canopy assembly of claim 6, wherein the third panel includes an electrical accessory configured to electrically couple to the electrical interface.

8. The canopy assembly of claim 7, wherein the electrical interface is a first electrical interface of the first panel or the second panel, wherein the third panel includes a second electrical interface configured to interface with the first electrical interface.

9. The canopy assembly of claim 8, wherein the second electrical interface is integrated into the locking mechanism.

10. The canopy assembly of claim 8, wherein the accessory includes a solar panel coupled to the second electrical interface.

11. The canopy assembly of claim 8, wherein the third panel includes a third electrical interface electrically coupled to the second electrical interface, the third electrical interface configured to interface with the accessory, thereby electrically coupling the accessory to the first electrical interface.

12. The canopy assembly of claim 1, further comprising:
a fourth panel coupled to the first support and the second support; and
a fifth panel selectively insertable between the second panel and the fourth panel.

13. The canopy assembly of claim 12, wherein the third panel and the fifth panel are interchangeable.

14. The canopy assembly of claim 1, wherein:
the canopy includes a plurality of locking mechanisms;
the third panel includes:
a first portion including a first locking mechanism of the plurality of locking mechanisms;
a second portion including a second locking mechanism;
the first portion and the second portion are interchangeable.

15. The canopy assembly of claim 1, further comprising a windshield assembly coupled to the first support and the second support, the windshield assembly including a windshield that is repositionable between a closed configuration and an open configuration, the windshield positioned underneath and substantially parallel to the canopy when in the open configuration.

16. The canopy assembly of claim 15, wherein, when the third panel is removed from the canopy, a gap is present between the first panel and the second panel, and wherein, when the windshield is in the open configuration, the windshield at least partially extends across the gap.

17. The canopy assembly of claim 15, wherein:
the canopy defines a canopy cavity;
the canopy includes an accessory mount configured to facilitate coupling an accessory to the canopy; and
the canopy cavity has a depth such that, when the windshield is in the open configuration, the accessory is positioned between the canopy and the windshield.

18. The canopy assembly of claim 1, further comprising handles coupled to the third panel.

19. A canopy assembly for a recreational vehicle, the canopy assembly comprising:
a first support;
a second support, the first support and the second support configured to couple to the recreational vehicle;
a canopy supported by the first support and the second support, the canopy comprising:
a first panel coupled to the first support and the second support;
a strut coupled to the first support and the second support;
a second panel coupled to the first support, the second support, and the strut;
a third panel selectively insertable between the first panel and the second panel, the third panel including a first portion and a second portion that are interchangeable;
a first locking mechanism coupled to the first portion; and
a second locking mechanism coupled to the second portion, the first locking mechanism and the second locking mechanism configurable between a locked position or an unlocked position, wherein, when in the unlocked position, the first portion or the second portion is independently removable from the canopy; and
a windshield assembly coupled to the first support and the second support, the windshield assembly including a windshield that is repositionable between a closed configuration and an open configuration, the windshield positioned underneath and substantially parallel to the canopy when in the open configuration,
wherein when at least one of the first portion or the second portion is removed from the canopy, a gap is present between the first panel and the second panel; and
wherein, when the windshield is in the open configuration, the windshield at least partially extends across the gap.

20. A recreational vehicle comprising:
a chassis;
a body coupled to the chassis;
a prime mover;
a plurality of tractive elements, at least one of the plurality of tractive elements driven by the prime mover;
a first support coupled to at least one of the chassis or the body;
a second support coupled to at least one of the chassis or the body;
a canopy supported by the first support and the second support, the canopy including:
a first panel coupled to the first support and the second support;
a second panel coupled to the first support and the second support;
a third panel selectively insertable between the first panel and the second panel;
a locking mechanism reconfigurable between a locked position or an unlocked position, wherein, when in the unlocked position, the third panel is removable from the canopy; and
a seating assembly supported by the chassis;
wherein at least one of the body or the seating assembly defines a storage cavity configured to store the third panel when removed from the canopy.
